(19) United States
(12) Patent Application Publication
(10) Pub. No.: US 2014/0134968 A1
(43) Pub. Date: May 15, 2014

(54) METHOD FOR FILTERING INCOMING CALLS INTENDED TO BE IMPLEMENTED BY A DEVICE EMBEDDED IN A VEHICLE

(71) Applicant: Sierra Wireless, (US)

(72) Inventors: Djelal RAOUF, Boulogne Billancourt (FR); Nhon CHU, Bois le Roi (FR); Jérémie DUMONT, Gif sur Yvette (FR)

(73) Assignee: Sierra Wireless, Issy Ies Moulineaux (FR)

(21) Appl. No.: 13/855,250

(22) Filed: Apr. 2, 2013

(30) Foreign Application Priority Data
Apr. 4, 2012 (FR) 12/53066

(51) Int. Cl. H04W 4/16; H04W 4/12

(52) U.S. Cl. CPC H04W 4/16; H04W 4/12
USPC 455/404.1

(57) ABSTRACT

The present invention concerns a method for filtering incoming calls intended to be implemented by a device in a vehicle, said device previously having sent an emergency call to an emergency call center that manages the emergency calls and said device being in a state awaiting any incoming calls sent by callers. The method is characterized in that it comprises the following steps:
identifying the caller of each new incoming call,
if the identified caller is an emergency call center, then a communication between the device and an operator in the emergency call center is established, and
the device returns to the state of awaiting any incoming calls at the end of the communication.

The present invention concerns the field of emergency calls sent from a device embedded in a vehicle involved in an accident to a call center via a cellular communication network. More especially, the invention concerns the filtering by a device embedded in the vehicle of incoming calls sent by an emergency call center.

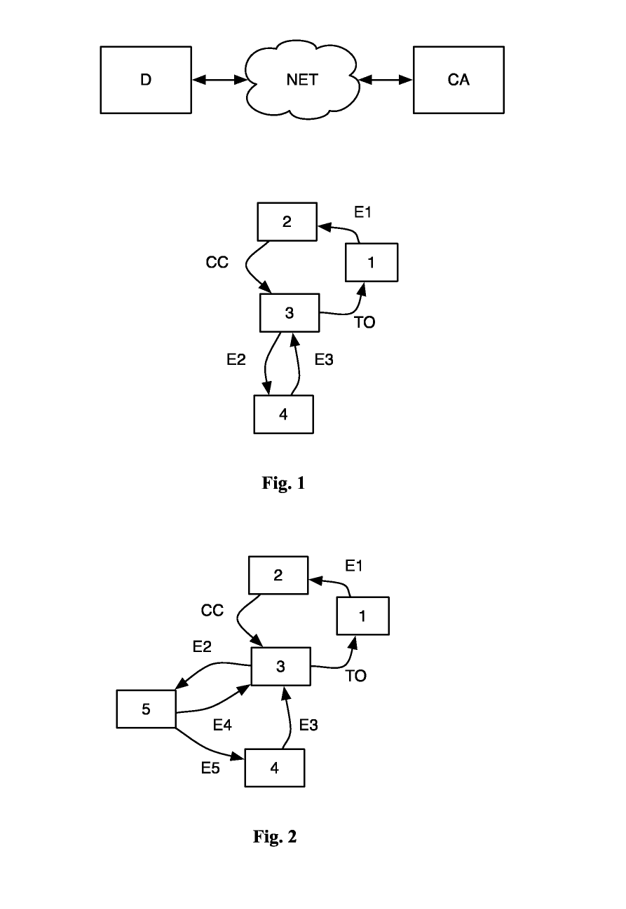

An emergency call system, illustrated at the top part of FIG. 1, enables a device D embedded in a vehicle involved in an accident to send an emergency call to an emergency call center CA via a cellular communication network NET.

In normal operation of the vehicle, the device D is in a so-called inactive state 1. Following an event E1, for example the triggering of an airbag system of the vehicle, the device D switches to an emergency call state 2 (Push mode).

In this state, the device D effects a geolocation of the vehicle. This geolocation may be done for any means available in the vehicle, for example by means of a satellite system such as GPS (Global Positioning System) or one of its homologues such as the Russian GLONASS or the European Galileo. In addition, an emergency call is requested either automatically by a computer on board the vehicle, or at the initiative of a user then on board this vehicle. The device D then dials a normal emergency number such as, for example, the numbers 112, 911, etc. and sends this demanded urgency call to this emergency number. The emergency call center CA then receives this emergency call.

Following the off-hooking of an operator in the emergency call center, it is usual for the device D to transmit, to the emergency call center CA, information relating firstly to the characteristics of the vehicle, such as for example a vehicle identification number (VIN code) and secondly its geolocation. Once this information has been received by the emergency call center CA, the user, via the device D, and the operator of the emergency call center CA dialogue with each other. Once their conversation has ended (event CC generally called Call Cleardown), the communication between the device D and the emergency call center CA is interrupted. The device D then switches to a state 3 of awaiting an incoming call (Standby), in which the device D is listening out for any new incoming calls in the device via the network NET. The device D usually remains in this state for a predetermined maximum time duration, typically 10 hours. Beyond this, an event TO (TimeOut) causes the device D switching to state 1.

The emergency call center CA then usually has all the information necessary for organizing rescue and has no longer any need to re-contact the user.

However, it is possible that the emergency call center needs to call back the user on board the vehicle in order to ask him, for example, for additional information. This function is usually called Callback.

To this end, the emergency call center CA sends a new call. This call is considered to be a new incoming call by the device D (event E2). The device D, in the state 3, switches to a voice communication state 4 (Pull mode) in which an attempt is made to establish a communication with the emergency center CA. At the end of the communication or if it is impossible to establish the communication (event E3), the device switches to the state 3.

As this new call is a simple voice call, meaning no information other than voice is transmitted at this time between the emergency call center CA and the device D, the device D cannot determine the identity of the caller and does not know whether the incoming call has been sent by the emergency call center CA, by another emergency call center or by a caller other than an emergency call center.

Thus, the device D processes any new incoming call systematically and identically: putting the new call on standby or call not considered. Consequently, if the device receives a call from an emergency call center when it is in communication with another caller (other than an emergency call center), the device D cannot determine whether the new incoming call has been sent by an emergency call center and cannot therefore hang up (or put the current call on standby) in order to favor the incoming call sent by the emergency call center. In other words, the device cannot allocate priority to the incoming calls and cannot establish incoming call management based on a priority mechanism.

The problem solved by the present invention is to remedy the aforementioned drawbacks.

To this end, the present invention concerns a method for filtering incoming calls intended to be implemented by a device in a vehicle. Said device previously having sent an emergency call to an emergency call center that manages the emergency calls and said device being in a state awaiting any incoming calls sent by callers, the method is characterized in that it comprises the following steps:
identifying the caller of each new incoming call,
if the identified caller is an emergency call center, then a communication between the device and an operator in the emergency call center is established, and
the device returns to the state of awaiting any potential incoming calls at the end of the communication.

The method allows sorting the incoming calls once the first emergency call has been sent by the device embedded in a vehicle. This sorting may either lead to the rejection of incoming calls that are not sent by an emergency call center, or allocate a priority to each incoming call. For example, a high priority may be allocated to an incoming call when this call is sent by the emergency call center and a low priority is allocated otherwise. It is also possible to provide for a pre-emption mechanism in the device enabling to interrupt or put on standby a current call as soon as a new incoming call is identified as having been sent by an emergency call center.

The features of the invention mentioned above, as well as others, will emerge more clearly from a reading of the following description of an example embodiment, said description being given in relation to the accompanying drawings, among which:

FIG. 1 schematically describes an emergency call system.

FIG. 2 represents a state diagram of a device of an emergency call system that implements the filtering method according to the present invention.

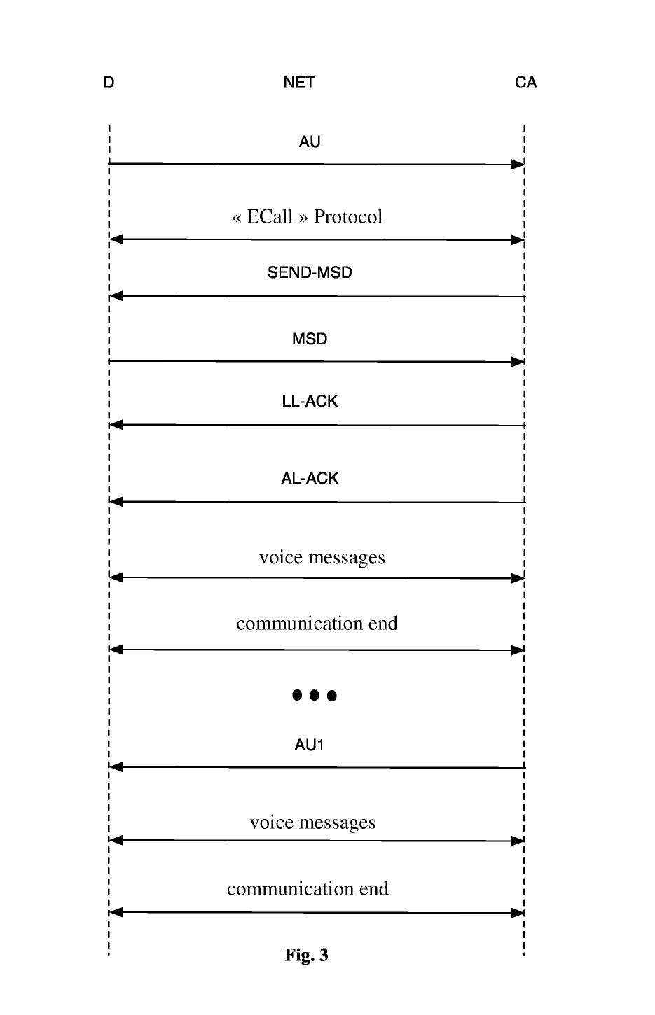

FIG. 3 represents an example of time sequencing of the exchanges between a device and an emergency call center.

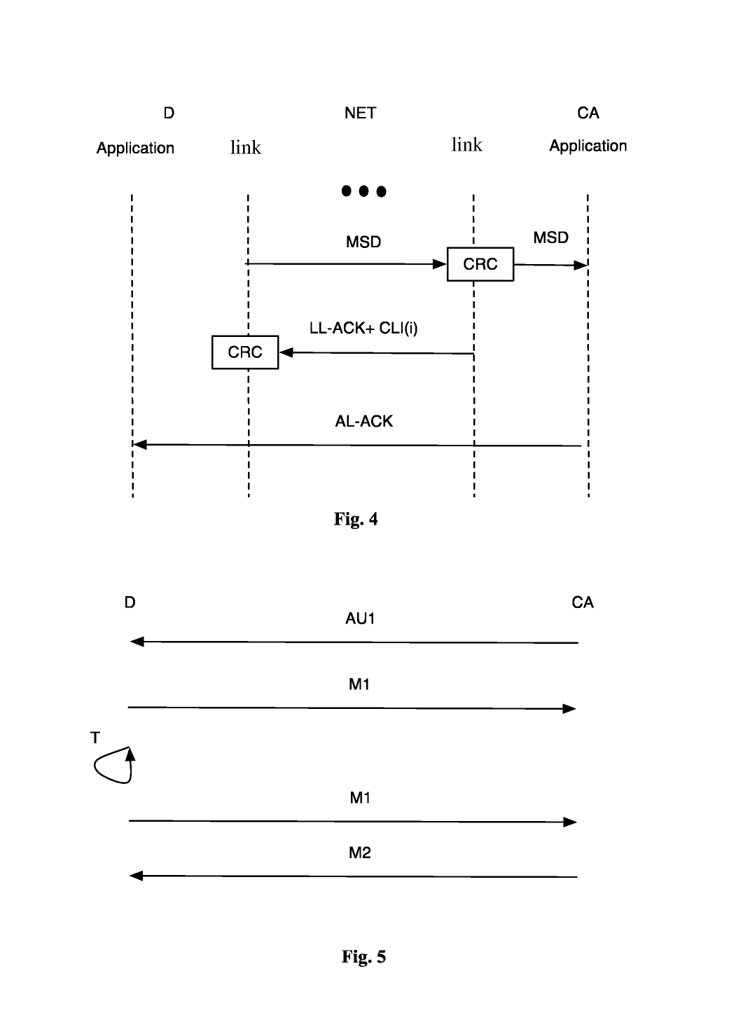

FIG. 4 represents an example of implementation of an embodiment of the filtering method in the time sequencing of FIG. 3.

FIG. 5 represents an example of implementation of another embodiment of the filtering method in the time sequencing of FIG. 3.

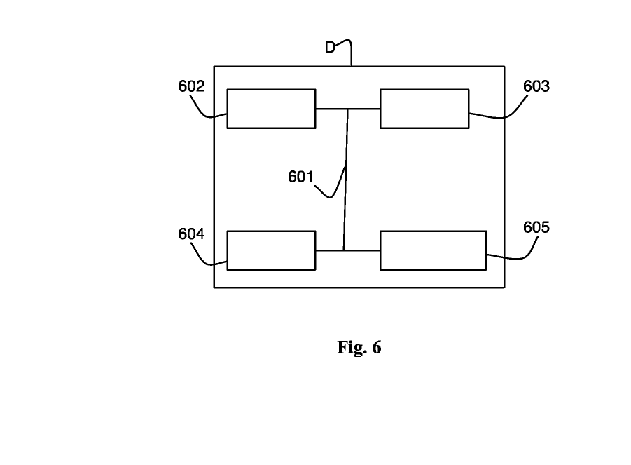

FIG. 6 represents an example of an internal architecture of the device D of an emergency call system.

In general terms, the present invention concerns a method for filtering incoming calls intended to be implemented by a device D embedded in a vehicle. The device D has previously sent an emergency call to an emergency call center CA and the device D is in the state 3 as described in the introductory part in relation to FIG. 1.

The elements in Figs. that are identical bear the same references.

FIG. 2 represents a state diagram of the device D that implements the filtering method according to the present invention.

The state diagram of FIG. 2 comprises a new filtering state 5 that corresponds to a special state of the device D in which this device identifies the caller of each incoming call and determines whether the incoming call has been sent by an emergency call center or by another caller.

Thus, when the device D is in the state 3, meaning it is listening out for any new incoming call, and an event E2 occurs, meaning a new incoming call arises, the device switches to the state 5 instead of switching to the state 4 as is the case according to FIG. 1.

If the caller is identified as not being an emergency call center, then the device switches to the state 3 (event E4).

If on the other hand the caller is identified as being an emergency call center, then the device D switches to the state 4 of voice communication and an attempt is made to establish a communication between the device D and the emergency call center. At the end of the communication or should it be impossible to establish the communication (event E3), the device switches to the state 3.

As will be realized, the filtering method according to the present invention may be implemented in any emergency call system that enables an emergency call center to call back a device D embedded in a vehicle.

By way of example of implementation of the filtering method, the means for implementing this method are now described in the context of a standardized emergency call system in the form of a 3GPP (3rd Generation Partnership Project) known by the generic name ECall. This system is an initiative of the European Commission aiming at increasing the number of lives saved during road accidents. This implementation is in no way limitative and is given only to illustrate one embodiment of the filtering method claimed.

According to this project, the state diagram in FIG. 1 is implemented by a succession of message exchanges described in FIG. 3 (ISO standard, EN 16062, pages 21-22, §7.4.5, §7.4.6 & §7.5). The device D, then in the state 2, commences by sending an emergency call AU to the emergency call center CA. Following off-hooking, a protocol, called “ECall protocol” according to the aforementioned standard, is then used for the device D to exchange messages with the emergency call center CA. One of these messages, called SEND-MSD, is sent by the emergency call center CA to request the device D to transmit to it information relating firstly to the characteristics of the vehicle and secondly to its geolocation. This transmission protocol uses a voice circuit with special modulation for transmitting data in the voice through a cellular network, 3G for example. This function is called “in-band modem”.

The device D then sends this information to the emergency call center CA in the form of a message called MSD (Minimum Set of Data) using this special modulation. Once the information has been received by the emergency call center CA, at least one acknowledgement message, called “LL-ACK” (level 2 acknowledgement of the OSI layer of the standard) or “AL-ACK” (level 5 acknowledgement of the OSI layer called HL-ACK according to the 3GPP standard TS 26.267), is sent by the emergency call center CA and received by the device D. The message AL-ACK certifies that the information sent has been correctly received by the emergency call center CA.

The message LL-ACK is in fact an LL (Link-Layer) message containing the code ACK with binary representation 0010 according to the description given in TS 3GPP 26.267 release 9 section 6.1.2 BCH Encoding.

The codes 0100 to 1111 are indicated as unused.

The user and the operator of the emergency call center CA then dialogue with each other. Once their conversation is ended (event CC), the communication is interrupted and the device D switches to the state 3.

Following the occurrence of the event E2 (new incoming call AU1), the device switches into the state 5 and it is determined whether the caller of this incoming call is an emergency call center. If the caller is identified as not being an emergency call center, then the device switches to the state 3, and if on the other hand the caller is identified as being an emergency call center then the device D switches into the state 4 as explained in relation to FIG. 2.

According to one embodiment of the method, a caller of a new incoming call is identified by the device D from a received special message that this caller has sent to the device D.

According to a variant of this embodiment, this special message bears the number of the caller (Caller Line Identifier).

This variant is advantageous since it enables the device D to determine whether the new incoming call has been sent by the emergency call center to which the device D has sent its emergency call.

Advantageously, the device D previously records, optionally in a data base, at least one number of an emergency call center and the number of a caller is then compared with each recorded emergency call center number, the caller then being considered to be an emergency call center when his number is identical to one of the recorded numbers.

This is particularly advantageous when the number of the emergency call center may vary according to the location of the vehicle involved in the accident or according to the operator managing the emergency call center close to the vehicle involved in the accident.

The emergency call center number or numbers recorded by the device D may, according to a variant, be updated (added, deleted) following the reception of a message that bears an emergency call center number. This updating is done following the reception either of certain messages that bear an emergency call center number or of each special message that bears an emergency call center number.

According to a variant of this embodiment, the number of the caller is transmitted from the caller to the device D in the form of a voice modulated signal.

An example of such a transmission method is known by the term “in-band modem”.

The number of the caller is carried in the acknowledgement message LL mentioned above.

FIG. 4 shows an example of implementation of a method of implementing the filtering method in the time sequencing of FIG. 3.

According to this implementation, an acknowledgement message LL is used defined by the aforementioned standard so that an emergency center CA sends its identifier number.

Following the reception of the message MSD, the emergency call center CA, at its so-called link layer (OSI model), checks that the transmission has been correctly made (CRC check). The information relating to the characteristics of the device D and its geolocation are then sent to the application layer for processing. At the link layer level, the emergency call center CA sends the acknowledgement message LL-ACK in the case where the CRC check is positive. Once the message LL-ACK has been received, the device D and the emergency call center CA switch into a transmission mode for the call number CLI. In this particular operating mode, for each figure CLI (i) of the call number CLI, the emergency call center CA sends a message LL described according to TS 3GPP 26.267 release 9, section 6.1.4.1 Link-layer feedback messages and containing, in the field DL-Data mentioned in the previous standard, the figure encoded for example in the following way:

0→0100

1→0101

. . .

9→1101

On the device side, it is checked at its link layer whether the transmission of a message LL+CLI(i) has been done correctly (CRC check). The last message LL sent contains a special code, for example 1111, to indicate the end of the transmission of the call number CLI.

The emergency call center CA and the device D then switch from the mode for transmission of the call number CLI to a mode for reception/transmission of a message AL-ACK. The emergency call center CA then sends, to the device D, the acknowledgement message AL-ACK defined according to the aforementioned standard.

It may be noted that the same method for transmission of the call number CLI can be implemented using the messages AL-ACK instead of the messages LL since a message AL-ACK is very similar in its encoding to the message LL with the exception of the synchronizing frame, which is reversed (TS 3GPP 26.267 release 9 section 6.1.4.2 Higher-Layer Acknowledgement Message).

As seen previously, according to one embodiment of the method, a caller of a new incoming call is identified by the device D from a received special message that this caller has sent to the device D.

According to a variant of this embodiment, this special message bears the name of the caller. This special message is for example a message of the CNAP (Calling Name Presentation) mechanism described in the 3GPP standard TS 24.096 Release 10. The name of the emergency call center CA may be a standard string, for example “eCall PSAP”. This name is preferably stored in the directory of the cellular network NET with the telephone number. When a call is established, the cellular network NET then using the CNAP mechanism seeks the name of the caller from his telephone number in the directory and communicates to the device D through the protocol described in the 3GPP standard TS 24.096 Release 10, section 4.

This variant is advantageous since it enables the device D to determine whether the new incoming call has been sent by the emergency call center to which the device D has sent its emergency call.

Advantageously, the device D previously stores, optionally in a database, at least one name of an emergency call center and the name of a caller is then compared with each emergency call center name stored, the caller then being considered to be an emergency call center when his name is identical to one of the names stored. In an equivalent manner, the name of the caller may be identical to a name contained in a stored character string.

This is particularly advantageous when the name of the emergency call center may vary according to the location of the vehicle involved in the accident or according to the operator managing the emergency call center close to the vehicle involved in the accident.

In addition, the variant using names rather than caller numbers is advantageous since the names may be less numerous than the numbers. The directory of the device D that contains the emergency call center identifiers may then be of reduced size. Another advantage of this variant with name is that the emergency call center no longer needs to transmit its identifier in advance, which makes the protocol more robust in the event of transmission errors in an emergency call context.

The emergency call center name or names stored by the device D may, according to one variant, be updated (added, deleted) following the reception of a message than bears an emergency call center name. This updating is done following the reception either of certain messages that bear an emergency call center name or of each special message that bears an emergency call center name.

According to a variant of this embodiment, the name of the caller is transmitted from the caller to the device D in the form of a voice modulated signal.

An example of such a transmission method is known by the term “in-band modem”.

According to another embodiment, a caller of a new incoming call is identified by the device D from the particular type of a received message that this caller has sent to the device D, the caller then being considered to be an emergency call center when the type of the received message is a message of a special protocol.

This embodiment is particularly advantageous since it requires no modification of the standard protocol.

This embodiment is illustrated in FIG. 5 described in relation to FIG. 2. The device D is in the state 3. Once the emergency call center has sent a new incoming call AU1 to the device D, the emergency call center CA waits to receive a special voice message M1. The device D, then in the state 3, receives the incoming call AU1 and switches to the state 5. It then sends, to the caller, the voice message M1 which it has optionally previously stored in one of its memories, and waits to receive another special message M2. The caller is then considered to be an emergency call center if the device receives said other special message M2 before the expiry of a predetermined period T. It may be noted that the illustration of FIG. 5 is only one example of implementation of the embodiment. Indeed, by reusing the terms of this example, it is possible, in a variant, for the device D to be awaiting receiving the message M2 without previously having sent the message M1.

If, at the end of this predetermined period T, no message M2 has been received, an event E4 is generated and the device D switches into the state 3 (event E4).

In a variant, at the end of this predetermined period T, the message M1 is re-sent by the device as long as a predetermined integer number N of retransmissions has not been reached. If this integer number is reached, the event E is generated and the device D switches into the state 3.

Following the reception of the message M1, the caller, which is then an emergency call center, sends the message M2 to the device D. Upon receiving this message M2 (event E5), the device D switches into the state 4 as explained in FIG. 2. In a variant, the message M2 is sent without prior reception of the message M1.

The message M2 is for example the message SEND-MSD.

FIG. 6 represents the architecture of a device implementing the claimed filtering method.

The device D comprises, connected by a communication bus 601, hardware resources that are very limited in terms of capacities, which are:

a processor, microprocessor or microcontroller 602;

a random access memory RAM 603;

a memory 604 of the ROM type (Read Only Memory) or flash memory or rewritable but remanent memory (such as in a USB key);

means 605 for interfacing with the cellular telephony network NET.

The microcontroller 602 is capable of executing instructions loaded into the RAM 603 from the memory 604. When the device D is powered up, the microcontroller 602 is capable of reading instructions from the RAM 603 and executing them. These instructions form a computer program that causes the implementation, by the microcontroller 602, of all or some of the methods described above in relation to FIGS. 1-5. The device D comprises means for identifying the caller of each new incoming call, in order to establish a communication between the device and an operator of the emergency call center if the identified caller is an emergency call center, and to return to the state of awaiting any incoming calls at the end of the communication.

These means are formed by the microcontroller 602, which cooperates with the memories 604 and RAM and the means 605 for example

All or some of the methods described above in relation to FIGS. 1-5 can be implemented in software by executing a set of instructions by a programmable machine, such as a DSP (Digital Signal Processor) or a microcontroller, such as the microcontroller 602, or be implemented in hardware by a dedicated machine or component, such as an FPGA (Field-Programmable Gate Array) or an ASIC (Application-Specific Integrated Circuit).

1. Method for filtering incoming calls implemented by a device embedded in a vehicle, said device previously having sent an emergency call to an emergency call center that manages the emergency calls and said device being in a state awaiting any incoming calls sent by callers, the method comprising the following steps:
identifying the caller of each new incoming call,
if the identified caller is an emergency call center, then a communication between the device and an operator in the emergency call center is established, and
the device returns to the state of awaiting any incoming calls at the end of the communication,
characterized in that, when said device receives each new incoming call, said device sends a special voice message (M1) to the caller and waits to receive another special message (M2), the caller then being considered to be an emergency call center when the device receives said other special message (M2) before expiry of a predetermined period (T).

2. Method according to claim 1, wherein, once the emergency call center has sent a new incoming call to the device, the emergency call center waits to receive said special voice message (M1).

3. Method according to claim 1, wherein, at the end of this predetermined period (T), said device resends said special message (M1) as long as a predetermined retransmission integer number is not reached.

4. Method according to claim 1, wherein a caller of a new incoming call is identified by the device from a special message received that this caller has sent to the device.

5. Method according to claim 4, wherein this special message bears the number or name of the caller.

6. Method according to claim 5, wherein the device previously records at least one number of an emergency call center and the number of a caller is then compared with each recorded emergency call center number, the caller then being considered to be an emergency call center when his number is identical to one of the recorded numbers.

7. Method according to claim 5, wherein the number of the caller is transmitted from the caller to the device in the form of a voice modulated signal.

8. Device for filtering incoming calls intended to be embedded in a vehicle, said device comprising means for sending an emergency call to an emergency call center that manages the emergency calls, said device being configured, when said device has previously sent an emergency call, to be in a state of awaiting any incoming calls sent by distant callers, said device comprising:
means for identifying the caller of each new incoming call,
means for establishing a communication with an operator of the emergency call center if the identified caller is an emergency call center, and
means for returning to the state of awaiting any incoming calls at the end of the communication,
characterized in that, when said device receives each new incoming call, said device implements:
means for sending a special voice message (M1) to the caller,
means for waiting to receive another special message (M2),
means for considering the caller to be an emergency call center when the device receives said other special message (M2) before expiry of a predetermined period (T).

9. Computer program product, characterized in that it comprises instructions for implementing the method according to claim 1, when said program is executed by a processor.

10. Storage means that can be read by a computer, characterized in that they store a computer program comprising instructions for implementing the method according to claim 1, when said program is executed by a processor.
